(19) United States
(12) Patent Application Publication
(10) Pub. No.: US 2022/0021280 A1
(43) Pub. Date: Jan. 20, 2022

(54) MAGNETO-RESISTIVE SINUSOIDAL COMMUTATION

(71) Applicant: Jordan James McBain, Allegan, MI (US)

(72) Inventor: Jordan James McBain, Allegan, MI (US)

(73) Assignee: Cool Mechatronics, Commerce Township, MI (US)

(21) Appl. No.: 17/246,684

(22) Filed: May 2, 2021

(51) Int. Cl. H02K 11/33; H02K 7/00; H02K 1/27; H02K 1/16

(52) U.S. Cl. CPC H02K 11/33; H02K 1/16; H02K 1/27; H02K 7/003

(57) ABSTRACT

Efficient motor commutation has in the past been challenged by limitations of shaft positioning sensors and a microcontroller's complex algorithms employed to switch an inverter once the shaft's position is inferred. While counter intuitive, this invention purports to do away with the complexities of typical field-oriented control by transferring control back into the analog domain. A magneto-resistive sensor generates precisely the waveform which an inverter would typically generate but with fixed amplitude; therefore, this sensor's output is fed into a voltage-controlled amplifier (VCA) followed by a class-d amplifier then fed to the motor's phases. The effect is to reduce the motor commutation problem to an audio amplifier; a greatly simplified microcontroller can then be used to sample the motor's position and vary a voltage command line to the VCA to achieve speed control.

### CROSS-REFERENCE TO RELATED APPLICATIONS

This application is a continuation-in-part of the U.S. application Ser. No. 15/859,658 filed 31 Dec. 2017 by Jordan McBain and entitled “Phase-Shifting Sinusoidal Commutation with Optional Rotary Transformer.” This application claims priority to the U.S. application Ser. No. 16/658,073 filed 19 Oct. 2019 by Jordan McBain entitled “Magneto-Resistive Sinusoidal Commutation.”

### BACKGROUND OF THE INVENTION

### 1. Field of the Invention

An apparatus for magneto-resistive sinusoidal commutation.

### 2. Description of the Prior Art

Brushless-DC motor commutation is normally achieved by a microcontroller which samples the angular displacement of a rotating shaft with the aid of a sensor (e.g. hall effect, resolver or magneto resistive). This microcontroller then switches current to (typically) three coils of wire each of which generates an electromagnet whose magnetic force is applied on a permanent magnet affixed on the rotating shaft. The waveform the microcontroller attempts to generate is dependent on the position of the shaft and is typically of sinusoidal form having time-varying instantaneous frequency that is commensurate with that of the angular displacement of the rotating shaft. A magneto-resistive sensor generates precisely such a waveform.

Therefore, the essential elements of the prior art consist of a stator system and a rotating shaft. The rotating shaft is rotatably mounted within the stator system with an axis of rotation defined by this rotatable mounting. One or more rotor magnets, having a magnetic field with a magnetic polarization, are affixed to the rotating shaft such that the magnetic polarization of each of the rotor magnet(s) is not parallel with the axis of rotation of the rotating shaft.

One or more stator phases consisting of electromagnets are mechanically affixed to the stator system and are formed by electrical leads at opposing ends of windings of insulated electrically conductive material each lead of which is electrically continuous with the other. The stator phases are disposed about the rotor magnets to deliver an electromagnetic force onto the rotor magnets when electric current is applied to the stator phases.

In some applications the microcontroller receives information about the position of the rotating shaft, which it is attempting to spin, by some form of shaft sinusoid generating circuit. Such shaft sinusoid generating circuits consist of output terminals which are supplied by electrical components that generate an electrical signal having sinusoidal form whose instantaneous frequency is commensurate with the instantaneous frequency of the angular displacement of the rotating shaft. The shaft sinusoid generating circuits typically measure the angular displacement of the rotating shaft using one or more positioning magnets that have a diametrically polarized magnetic field. The positioning magnets are mechanically affixed at an extreme of the length of the rotating shaft with the diametrically polarized magnetic field at right angles to the rotating shaft's axis of rotation while the rotor magnets have a diametric magnetization which is aligned with the positioning magnets' diametrically polarized magnetic field. In such a configuration, a magneto-resistive sensor provides an excellent form for realizing the shaft sinusoid generating circuits (for instance NXP's KMZ60).

In a typical three-phase configuration, one rotor magnet is affixed to the rotating shaft such that its magnetic polarization is substantially at right angles to the rotating shaft's axis of rotation. Three stator phases are typically configured in a plane about the rotor magnet at substantially one hundred and twenty degrees to each of the other stator phases.

The typical operation of the microcontroller in BLDC commutation acts analogously to an amplifier. This invention combines the more traditional notion of an amplifying circuit that consists of input terminals, output terminals and circuitry receiving a signal at the amplifying circuits' input terminals whose form is amplified and then supplied at the amplifying circuits' output terminals.

It is quite common to find amplifier technology consisting of voltage-controlled amplifying circuits that feed class-d amplifying circuits. The voltage-controlled amplifying circuits are formed by signal input terminals receiving a signal supplied at the input terminals of the amplifying circuits. The voltage-controlled amplifying circuit also receives a voltage command line that carries a voltage level indicating how much amplification to provide. The voltage-controlled amplifying circuit has circuitry that generates an amplified version of the signal supplied at the voltage-controlled amplifying circuit's signal input terminals which is provided at the voltage-controlled amplifying circuit's output terminals. The magnitude of the amplified signal created by the voltage-controlled amplifying circuit is commensurate with the voltage level received on the voltage command line.

The class-d amplifying circuit has signal input terminals receiving the signal supplied at the output terminals of the amplifying circuits' voltage-controlled amplifying circuit. The class-d amplifying circuit also receives a current source that generates a stream of electrical current (for instance, a battery). The current source is then modulated by the class-d amplifying circuit's circuitry causing the class-d amplifying circuit's output terminals to receive an amplified form of the signal supplied at the class-d amplifying circuit's signal input terminals. Typically, the class-d amplifying circuit's circuitry is achieved by modulating the current source by switching MOSFETs off and on.

### SUMMARY OF THE INVENTION

The novelty in this invention lies in the simple combination of one or more stator phases being supplied with the output terminals of one of the amplifying circuits where the input terminals of the amplifying circuits are connected to the output terminals of one of the shaft sinusoid generating circuits. The shaft sinusoid generating circuit is realized by a magneto-resistive sensor.

Magneto-resistive sensors are steeped in complex notions of quantum mechanics; however, they leverage the simple notion of the magneto-resistive effect which provides that the resistance of a conductor varies in the presence of a magnetic field. Such sensors can be found on the market today with two channels each being ninety-degrees out of phase with the other which are achieved with two Wheatstone bridges plus supporting conditioning circuitry. This invention leverages the simplification of employing a three-channel magneto-resistive sensor each channel being one hundred and twenty degrees out of phase with the others (such a sensor is available commercially off the shelf in the form of TE's KMT36H).

### Advantages of the Invention

The invention in U.S. application Ser. No. 15/859,658, of which this patent is a continuation in part, attempted to use a single magneto-resistive sensor supplied to one stator phase while other stator phases were supplied by circuitry generating a phase-shifted version of the single magneto-resistive sensor's outputs. The phase-shifting circuits needed to achieve the desired functionality are of a greater degree of complexity and cost to the circuitry necessary to the teachings exposed in this application.

The simplicity of the invention is marked by the failure of others in the field of brushless DC commutation who have not, as of yet, taken this unorthodoxed step of transferring commutation control back into the analog world out of the digital world of the microcontroller. In a sense, this patent teaches away from the established digital practice where a microcontroller samples a motor's position to control the waveform applied to a motor's coils. Functioning magneto-resistive sensors have been available since the 1990's and TE's KM36TH has been on the market since 2008.

The trend in the field of brushless DC commutation (BLDC) is towards sensorless control of a motor. The motivation is to eliminate the cost of the sensor and its supporting elements as a means of providing feedback to the microcontroller. Instead, the microcontroller monitors field currents for zero crossings as a means of determining rotating shaft position. However, such measurements require a microcontroller with a faster clock rate and bandwidth to be able to support the complex algorithms used to achieve commutation in this context. The costs of the change in microcontroller often offset the costs of the elimination of the sensor under today's economies of scale.

The circuitry in the teachings of this invention adds the expense of a multitude of operational amplifiers and other supporting circuity but should allow for a less expensive supervising microcontroller.

The microcontroller's maximum clock rate also poses an upper barrier to increasing the motor's rate of spin.

Even without sensorless commutation, BLDC is a complex task.

The invention in its broadest aspect provides for magneto-resistive sinusoidal commutation.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a block diagram of the proposed circuit.

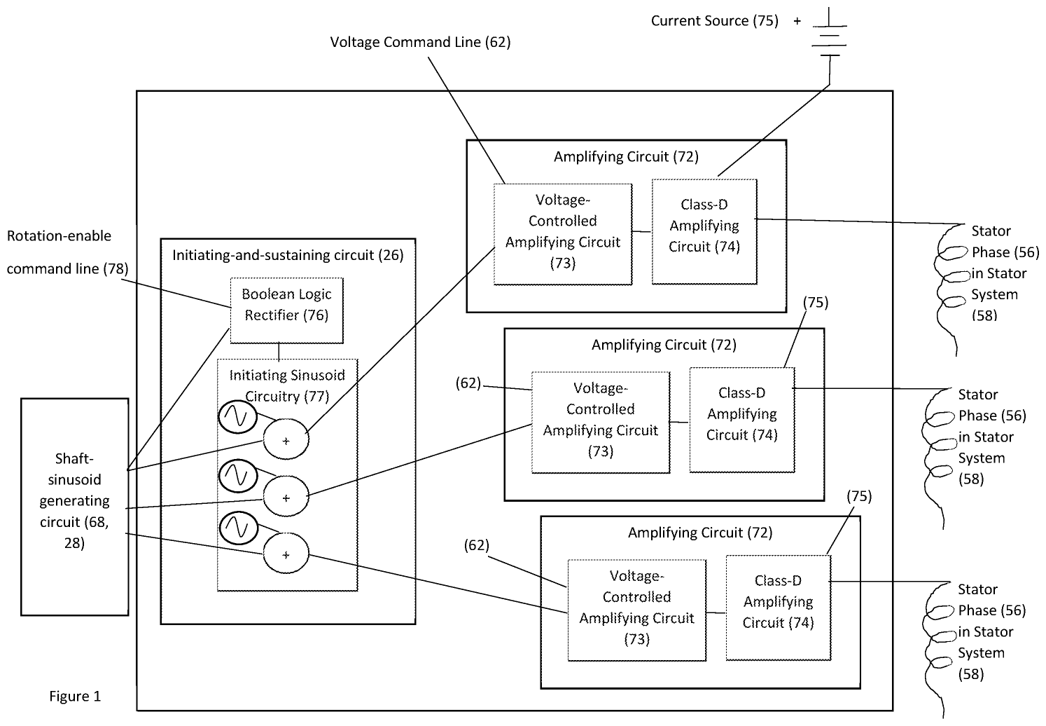

FIG. 2 is an electrical schematic of the proposed circuit with annotations.

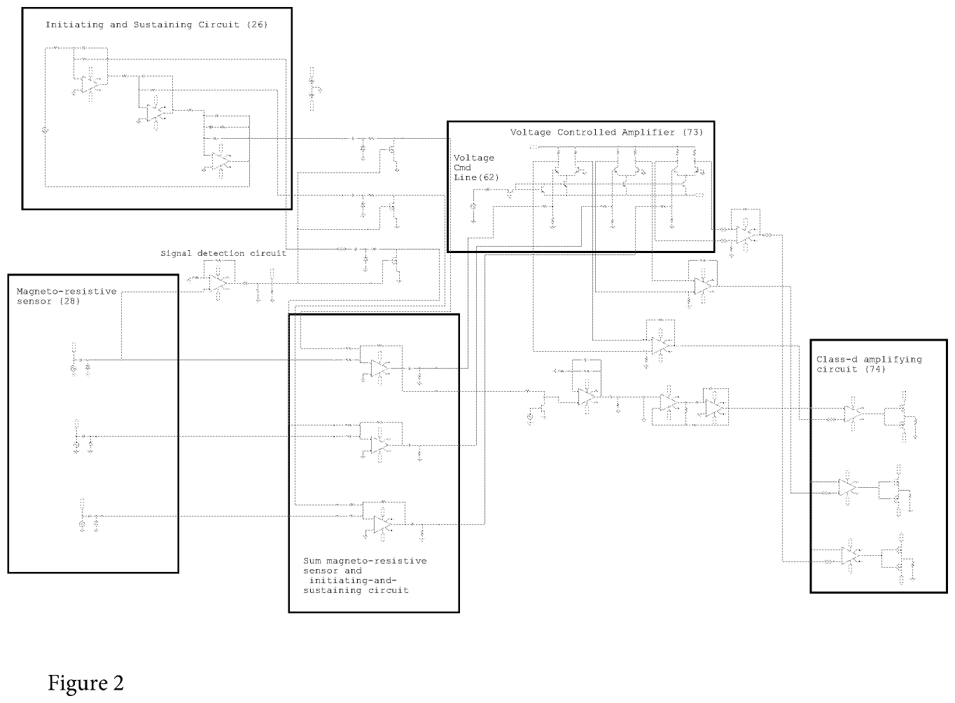

FIG. 3 is a perspective view of the mechanical components with the stator system shown in cut away.

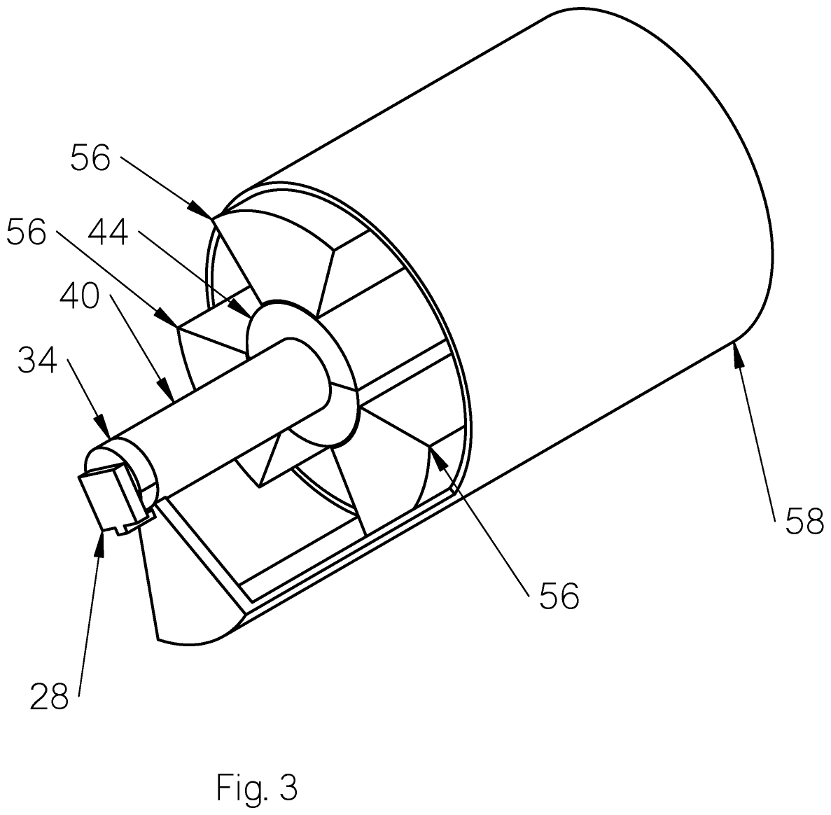

### DESCRIPTION OF THE ENABLING EMBODIMENT

Referring to the figures, wherein like numerals indicate corresponding parts throughout the several views, enabling embodiments of an apparatus for magneto-resistive sinusoidal commutation in accordance with the subject invention are illustrated.

A stator system (58) is employed to host a rotating shaft (40) which is rotatably mounted within the stator system (58). This rotatable mount defines the rotating shaft's (40) axis of rotation. One or more rotor magnet(s) (44) having a magnetic field with a magnetic polarization are affixed to the rotating shaft (40) such that the magnetic polarization of each of the rotor magnet(s) (44) is not parallel with the axis of rotation of said rotating shaft (40).

One or more stator phase(s) (56) are mechanically affixed to the stator system (58) and are disposed about the rotor magnets (44) to deliver an electromagnetic force onto the rotor magnet(s) (44) when electric current is applied to the stator phase(s) (56). The stator phase(s) (56) consist of electromagnets having electrical leads at opposing ends of windings of insulated electrically conductive material with one lead being electrically continuous with the other.

The invention employs one or more shaft sinusoid generating circuit(s) (68) having output terminals which are supplied by electrical components that generate an electrical signal having sinusoidal form whose instantaneous frequency is commensurate with the instantaneous frequency of the angular displacement of the rotating shaft (40).

One or more amplifying circuits (72), having input terminals and output terminals, are deployed to amplify the shaft sinusoid generating circuit(s) (68). The amplifying circuits' (72) input terminals receiving a signal whose form is amplified by circuitry within the amplifying circuits (72) which is then supplied at the amplifying circuits' (72) output terminals. The leads of one or more of the stator phase(s) (56) are supplied with the output terminals of one of the amplifying circuits (72) where the input terminals of the amplifying circuits (72) are connected to the output terminals of one of the shaft sinusoid generating circuits (68).

The shaft sinusoid generating circuits (68) are realized with one or more magneto-resistive sensor(s) (28). The position of the shaft is transmitted to the shaft sinusoid generating circuit(s) (68) by one or more positioning magnet(s) (34) each having a diametrically polarized magnetic field. The rotating shaft (40) has two ends onto which one or more of the positioning magnet(s) (34) are mechanically affixed; the positioning magnets' (34) diametrically polarized magnetic field is disposed at right angles to the rotating shaft's (40) axis of rotation. Furthermore, the rotor magnets (44) have a diametric magnetization aligned with the positioning magnets' (34) diametrically polarized magnetic field. One or more of the magneto-resistive sensor(s) (28) are disposed in proximity to one of the positioning magnet(s) (34) affixed at one of the rotating shaft's (40) end.

The amplifying circuits (72) are comprised of a voltage-controlled amplifying circuit (73) and a class-d amplifying circuit (74). The amplifying circuits (72) receive a voltage command line (62) carrying a voltage level indicating the level of amplification desired. The amplifying circuits (72) also receive a current source (75) generating a stream of electrical current (for instance, a battery). The voltage-controlled amplifying circuit (73) has signal input terminals which receives the signal supplied at the input terminals of the voltage-controlled amplifying circuit's (73) amplifying circuits (72). The voltage-controlled amplifying circuit (73) has circuitry capable of amplifying a signal supplied at the voltage-controlled amplifying circuit's (73) signal input terminals where the magnitude of this amplified signal is commensurate with the voltage level received on the voltage command line (62). The amplified signal of the voltage-controlled amplifying circuit (73) is supplied at the voltage-controlled amplifying circuit's (73) output terminals which are in turn connected to the class-d amplifying circuit's (74) signal input terminals. The class-d amplifying circuit (74) receives the current source (75). The class-d amplifying circuit (74) has output terminals connected to the output terminals of the amplifying circuits (72). The class-d amplifying circuit (74) has circuitry causing the class-d amplifying circuit's (74) output terminals to receive current modulated from the current source (75) in the form of the signal supplied to the class-d amplifying circuit's (74) signal input terminals.

Motor startup is achieved by an initiating-and-sustaining circuit (26) which receives a rotation-enable command line (78) carrying a voltage level, the amount of which indicates to either enable or disable circuit energization but not both at the same time. The initiating-and-sustaining circuit (26) has output terminals and signal input terminals. The initiating-and-sustaining circuit (26) is connected in between the shaft sinusoid generating circuit (68) and the amplifying circuits (72) by connecting the shaft sinusoid generating circuit's (68) output terminals to the initiating-and-sustaining circuit's (26) signal input terminals and connecting the initiating-and-sustaining circuit's (26) output terminals to the amplifying circuits' (72) input terminals.

The initiating-and-sustaining circuit (26) is composed of Boolean rectifying circuitry (76) and initiating sinusoid circuitry (77). The Boolean rectifying circuitry (76) receives the output terminals of the shaft sinusoid generating circuit (68) and is configured to cause the initiating sinusoid circuitry (77) to generate a sinusoidal voltage signal that is summed with the signal supplied at the shaft sinusoid generating circuit's (68) output terminals whose summation is in turn provided at the initiating-and-sustaining circuit's (26) output terminals when, and only when, there is no variation in the signal supplied by the shaft sinusoid generating circuit (68) and the voltage level on the rotation-enable command line (78) indicates to enable circuit energization. Alternatively, the initiating-and-sustaining circuit's (26) circuitry supplies the shaft sinusoid generating circuit's (68) signal as its outputs when variation is present in the signal supplied by the shaft sinusoid generating circuit (68) and the voltage level on the rotation-enable command line (78) indicates to enable circuit energization.

A three-phase variant can be constructed by configuring the magnetic polarization of the rotor magnet (44) to be substantially at right angles to the axis of rotation of the rotating shaft (40). Three stator phases (56) are disposed in a plane about the rotor magnet (44) where each stator phase is angularly dispersed at substantially one hundred and twenty degrees from the remaining stator phases (56). In the three-phase variant, the shaft sinusoid generating circuit (68) has three sets of output terminals which are supplied by electrical components that generate electrical signals having sinusoidal form whose instantaneous frequency is commensurate with the instantaneous frequency of the angular displacement of the rotating shaft (40). Each signal on each of the shaft sinusoid generating circuit's (68) output terminals is substantially phase shifted by one hundred and twenty degrees from the other two.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed:

1. An apparatus for magneto-resistive sinusoidal commutation comprising:
a stator system;
a rotating shaft that is rotatably mounted within said stator system and has an axis of rotation defined by this rotatable mounting;
one or more rotor magnets having a magnetic field with a magnetic polarization, wherein one or more of said rotor magnets are affixed to said rotating shaft, such that the magnetic polarization of each of said one or more rotor magnets is not parallel with the axis of rotation of said rotating shaft;
one or more stator phases including electromagnets having electrical leads at opposing ends of windings of insulated electrically conductive material with one lead being electrically continuous with the other, wherein one or more of said stator phases are mechanically affixed to said stator system and disposed about said rotor magnets to deliver an electromagnetic force onto said rotor magnets when electric current is applied to said stator phases;
one or more shaft sinusoid generating circuits having output terminals which are supplied by electrical components that generate an electrical signal having sinusoidal form whose instantaneous frequency is commensurate with the instantaneous frequency of the angular displacement of said rotating shaft; and
one or more amplifying circuits that have:
input terminals and output terminals; and
circuitry receiving a signal at the input terminals of said amplifying circuits, the form of the signal being amplified and supplied at the output terminals of said amplifying circuits,
wherein:
the leads of one or more of said stator phases are supplied with the output terminals of one of said amplifying circuits; and
the input terminals of said amplifying circuits are connected to the output terminals of one of said shaft sinusoid generating circuits.

2. The apparatus of claim 1, wherein:
said rotor magnets have a diametric magnetization;
said rotating shaft has two ends defining said rotating shaft's finite length;
said shaft sinusoid generating circuits include one or more magneto-resistive sensors;
one or more positioning magnets have a diametrically polarized magnetic field;
one or more of said positioning magnets are mechanically affixed at an extreme of the length of said rotating shaft with a diametrically polarized magnetic field of said positioning magnets being oriented at right angles to said an axis of rotation of said rotating shaft;
the diametrically polarized magnetic field of the positioning magnet is aligned with a bipolar magnetization of said rotor magnet; and
one or more of said magneto-resistive sensors are disposed in proximity to one of said positioning magnets affixed at an extreme of the length of said rotating shaft.

3. The apparatus of claim 1, wherein:
the apparatus further comprises:
a voltage command line carrying a voltage level; and
a current source generating a stream of electrical current
said amplifying circuits have a voltage-controlled amplifying circuit and a class-d amplifying circuit;
said voltage-controlled amplifying circuit has signal input terminals receiving the signal supplied at the input terminals of said amplifying circuits;
said voltage-controlled amplifying circuit also receives said voltage command line;
said voltage-controlled amplifying circuit has output terminals;
said voltage-controlled amplifying circuit has circuitry generating an amplified signal supplied at input terminals of said voltage-controlled amplifying circuit, wherein the magnitude of said amplified signal is commensurate with the voltage level received on said voltage command line;
said amplified signal of said voltage-controlled amplifying circuit is supplied at said output terminals of said voltage-controlled amplifying circuit;
said class-d amplifying circuit has signal input terminals receiving the signal supplied at the output terminals of the voltage-controlled amplifying circuit of said amplifying circuits;
said class-d amplifying circuit receives said current source;
said class-d amplifying circuit has output terminals connected to the output terminals of said amplifying circuits; and
said class-d amplifying circuit has circuitry causing the output terminals of said class-d amplifying circuit to receive current modulated from said current source in the form of the signal supplied to the signal input terminals of said class-d amplifying circuit.

4. The apparatus of claim 1, wherein:
a rotation-enable command line carries a voltage level the amount of which indicates to either enable or disable circuit energization but not both at the same time;
the apparatus includes an initiating-and-sustaining circuit that:
has output terminals and signal input terminals; and
is connected in between said shaft sinusoid generating circuit and said amplifying circuits by connecting the output terminals of said shaft sinusoid generating circuit to the signal input terminals of said initiating-and-sustaining circuit and connecting the output terminals of said initiating-and-sustaining circuit to the input terminals of said amplifying circuits;
said initiating-and-sustaining circuit has Boolean rectifying circuitry and initiating sinusoid circuitry;
said Boolean rectifying circuitry receives said output terminals of said shaft sinusoid generating circuit and said Boolean rectifying circuitry has circuitry causing said initiating sinusoid circuitry to generate a sinusoidal voltage signal that is summed with the signal supplied at the output terminals of said shaft sinusoid generating circuit, the summation being in turn provided at the output terminals of said initiating-and-sustaining circuit when, and only when, there is no variation in the signal supplied by said shaft sinusoid generating circuit and the voltage level on said rotation-enable command line indicates to enable circuit energization; and
the circuitry of said initiating-and-sustaining circuit is wired to supply the signal of said shaft sinusoid generating circuit when variation is present in the signal supplied by said shaft sinusoid generating circuit and the voltage level on said rotation-enable command line indicates to enable circuit energization.

5. An apparatus for three-phase magneto-resistive sinusoidal commutation comprising:
a stator system;
a rotating shaft that is rotatably mounted within said stator system and has an axis of rotation defined by the rotatable mounting;
one rotor magnet that:
has a magnetic field with a magnetic polarization; and
is affixed to said rotating shaft such that the magnetic polarization of said rotor magnet is substantially at right angles to the axis of rotation of said rotating shaft;
three stator phases that:
include electromagnets having electrical leads at opposing ends of windings of insulated electrically conductive material with one lead being electrically continuous with the other;
are mechanically affixed to said stator system in a plane at substantially right angles to the axis of rotation of said rotating shaft; and
are disposed about said rotor magnet, wherein each stator phase is angularly dispersed at substantially one hundred and twenty degrees from the remaining stator phases;
a shaft sinusoid generating circuit having three sets of output terminals which are supplied by electrical components that generate electrical signals having sinusoidal form with an instantaneous frequency that is commensurate with the instantaneous frequency of the angular displacement of said rotating shaft; and
one or more amplifying circuits having input terminals and output terminals, wherein:
each signal on each the output terminals of said shaft sinusoid generating circuit is substantially phase shifted by one hundred and twenty degrees from the other two;
said amplifying circuits have circuitry receiving a signal at the input terminals of said amplifying circuits, the signal having a form that is amplified and supplied at the output terminals of said amplifying circuits;
the leads of each stator phase is supplied with the output terminals of one of said amplifying circuits; and
the input terminals of said amplifying circuits are connected to the output terminals of one the output terminals of said shaft sinusoid generating circuit.

6. The apparatus of claim 5, wherein:
said rotor magnets have a bipolar magnetization;
said rotating shaft has two ends defining the rotating shafts finite length;
one or more positioning magnets have a diametrically polarized magnetic field;
one or more of said positioning magnets are mechanically affixed at an extreme of the length of said rotating shaft, the diametrically polarized magnetic field of said positioning magnets being oriented at right angles to the axis of rotation of said rotating shaft;
the diametrically polarized magnetic field of the positioning magnet is aligned with a bipolar magnetization of said rotor magnet; and
one or more of said magneto-resistive sensors are disposed in proximity to one of said positioning magnets affixed at an extreme of the length of said rotating shaft.

7. The apparatus of claim 6, wherein:
said shaft sinusoid generating circuit includes three Wheatstone bridges configured with supporting signal conditioning circuitry configured to leverage the magneto-resistive effect to generate three signals having sinusoidal form having an instantaneous frequency that is commensurate with the instantaneous frequency of the angular displacement of said rotating shaft, each of which has a phase shift substantially at one hundred and twenty degrees from the remaining two.
